(19) United States
(12) Patent Application Publication
(10) Pub. No.: US 2023/0419396 A1
(43) Pub. Date: Dec. 28, 2023

(54) DYNAMIC TRANSACTION SYSTEM USING COUNTERFACTUAL MACHINE-LEARNING ANALYSIS

(71) Applicant: eBay Inc., San Jose, CA (US)

(72) Inventors: Stephanie Michelle Moyerman, Phoenix, AZ (US); Kishore Paul, San Jose, CA (US)

(21) Appl. No.: 17/846,474

(22) Filed: Jun. 22, 2022

(51) Int. Cl. G06Q 30/08; G06Q 30/02; G06Q 30/06; G06Q 10/08; G06K 9/62

(52) U.S. Cl. CPC G06Q 30/08; G06Q 30/0283; G06Q 30/0271; G06Q 30/0641; G06Q 10/08345; G06K 9/6256

(57) ABSTRACT

Systems and methods are directed to using counterfactual machine-learning analysis to improve a probability of transaction conversion. The system trains a model with training data extracted from past transactions, whereby the model determines a probability for transaction conversion based in part on user account behavior. The system monitors the user account behavior associated with a potential buyer including tracking a first action performed involving an item of a listing. A user attribute associated with the user account and an item attribute associated with the item are determined. Based on the first action, the probability is determined by applying the user attribute, the item attribute, and the user account behavior to the model. Based on the probability being less than a conversion threshold, counterfactual analysis is performed to identify a change associated with the item that results in the probability exceeding the conversion threshold. The change may be automatically implemented.

### TECHNICAL FIELD

The subject matter disclosed herein generally relates to network transactions. Specifically, the present disclosure addresses systems and methods that dynamically personalizes elements of an online session based on counterfactual machine-learning analysis.

### BACKGROUND

Conventional transaction systems do not dynamically adjust elements (e.g., pricing) of items during an online session. Specifically, the prices of goods in these conventional transaction systems are fixed at an item level. While bidding may be provided in auction environments, there is no dynamic pricing that is personalized to a customer. Without personalization, customers get a generic impression of a site of the conventional transaction system and may cost compare across the market with the non-personalized fixed value in mind.

### BRIEF DESCRIPTION OF THE DRAWINGS

FIG. 1 is a diagram illustrating an example network environment suitable for dynamically personalizing elements of an online session based on counterfactual machine-learning analysis, according to example embodiments.

FIG. 2 is a diagram illustrating components of a machine learning system, according to example embodiments.

FIG. 3 is a flowchart illustrating operations of a method for machine-training a conversion probability model, according to example embodiments.

FIG. 4 is a flowchart illustrating operations of a method for dynamically personalizing elements of the online session based on counterfactual machine-learning analysis, according to example embodiments.

FIG. 5 is a flowchart illustrating operations of a method for performing machine-learning analysis based on user account actions, according to example embodiments.

FIG. 6 is a flowchart illustrating operations of a method for performing counterfactual analysis, according to example embodiments.

FIG. 7 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Systems and methods that machine-train (i.e., using machine-learning) a conversion probability model and apply the conversion probability model to monitored behaviors associated with a user account of a user (e.g., potential buyer) are discussed herein. The monitored behaviors can include one or more actions performed by the user account involving an item of a listing. These actions can include one or more of viewing the listing, lingering on the list, adding the item of the listing to a cart, viewing a cart user interface with the item in the cart, saving the art, deleting the item from the cart, and/or proceeding to checkout. Based on a current action being performed by the user (also referred to as the “user account”), one or more user attributes associated with the user account, and one or more item attributes associated with the item, along with the user behavior are applied to the conversion probability model to determine a probability for a transaction conversion (i.e., completing the transaction).

In various embodiments, counterfactual analysis is performed. Counterfactual analysis attempts to identify an adjustment to an attribute or parameter that will nudge the user toward completing the transaction or to perform the next operation (e.g., increasing the conversion probability). For example, if the current action is the user viewing/displaying a listing, the nudge is to add the item to the cart. In another example, if the current action is adding the item to the cart, then the nudge is to checkout (e.g., view the checkout user interface). In a further example, if the current action is viewing the cart or checkout user interface, the nudge is to complete the checkout.

Thus, in some embodiments, if the probability does not transgress a conversion threshold (e.g., 51% or 55%), counterfactual analysis is performed to identify a change associate with the item (or item attribute) that results in the probability exceeding the conversion threshold. In other embodiments, the counterfactual analysis may be performed regardless of the probability. In these embodiments, the counterfactual analysis is performed to increase the probability for transaction conversion, whereby the change that is identified has the highest probability among a plurality of changes that are tested using counterfactual analysis. The change is then automatically implemented by the system without any human interaction. The change can comprise changing a price of the item, providing an incentive (e.g., a coupon, a discount, a cashback reward), changing shipping cost, or providing an upsell opportunity. The upsell opportunity can be, for example, to an upgraded version of the item, to add one or more same/similar items to the cart at a discount, or to add one or more complimentary items to the cart at a discount.

The machine learning involves training on data from past transaction histories. Accordingly, the transaction histories of both completed transactions (e.g., buy pays and the sale is completed) and non-completed transactions (e.g., sale of items not completed) are accessed and various attributes extracted. The attributes (also referred to as “features”) can include item attributes such as prices of items, categories of the items, and/or shipping costs of the items. The attributes may also include attributes of buyers in these past transactions such as, for example, locations, payment instruments used, experience level (e.g., time on the system), and/or user behaviors. The user behaviors can include, for example, actions performed as users traverse an online shopping session, time spent viewing each page before performing an action (e.g., adding to cart, moving on to another page), how users arrive at various pages (e.g., listings, checkout cart), and whether the users completed or did not complete a transaction in each online session. The attributes may also include seller attributes such as, for example, locations, experience level, or ratings,

The conversion probability model is then trained with training data comprising the extracted features. The conversion probability model can be continuously updated (e.g., on a daily basis) based on new transaction data. In some embodiments, the conversion probability model comprises a long short-term memory model and the user account behavior applied to the conversion probability model, during runtime, includes a current action along with a last predetermined number of actions immediately prior to the current action. Thus, the conversion probability model may be a neural network in accordance with one embodiment.

Thus, the present disclosure provides technical solutions that dynamically personalizes elements of an online session that increases proclivity of a user to complete a transaction. Using known attributes of the user, their behavior as they traverse the shopping process, and item attributes, the system can dynamically change an element associated with the item (e.g., decrease price or shipping cost, provide an incentive or promotion) to increase a conversion probability. Thus, the technical solutions predict, using a machine-trained conversion probability model, whether a transaction conversion will likely occur, trigger a counterfactual analysis if the conversion probability is low, and change one or more elements associated with the item to increase the probability for transaction conversion. The technical solutions use machine-learning to train the conversional probability model that, at runtime, determines the probability for transaction conversion. New completed transactions can be used to retrain/refine the conversion probability model. Thus, the probability can be continuously modeled, learned, and changed (e.g., on a daily or weekly basis).

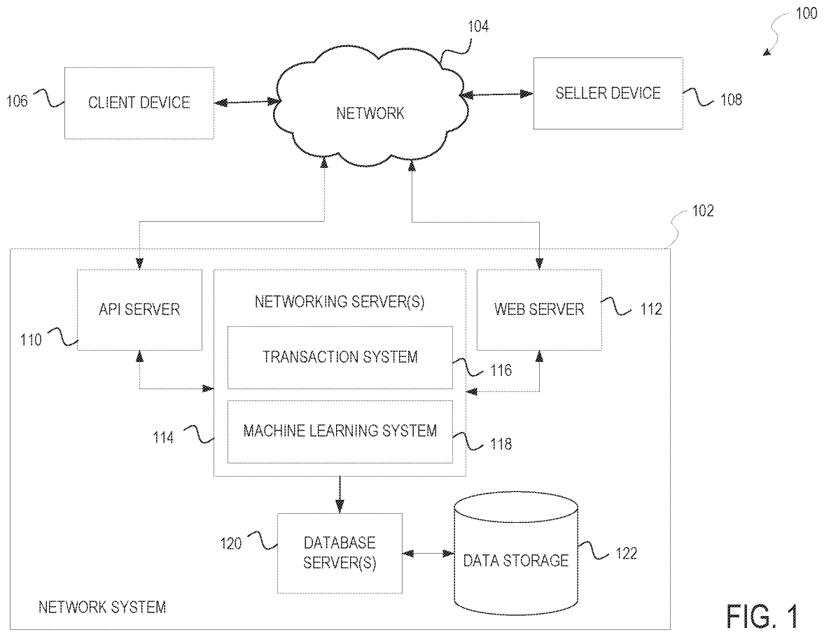

FIG. 1 is a diagram illustrating an example network environment 100 suitable for dynamically personalizing elements of an online session based on counterfactual machine-learning analysis, according to example embodiments. A network system 102 provides server-side functionality via a communication network 104 (e.g., the Internet, wireless network, cellular network, or a Wide Area Network (WAN)) to a client device 106 and a seller device 108. The network system 102 machine-trains a conversion probability model using transaction histories and, during runtime, applies the conversion probability model to user account behavior to determine a probability of transaction conversion (e.g., a probability that a next or future action will be checkout), as will be discussed in more detail below.

In various cases, the client device 106 is a device associated with the user account (e.g., the potential buyer) of the network system 102 viewing pages (e.g., item search user interface, listings, cart user interface) provided by the network system 102 during the online session, while the seller device 108 is a device associated with a seller account (e.g., a seller of one or more items) of the network system 102. The seller account can publish listings for the one or more items via the network system 102 as will be discussed in more detail below.

The client device 106 and seller device 108 interface with the network system 102 via a connection with the network 104. Depending on the form of the client device 106 and seller device 108, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The client device 106 and seller device 108 may comprise, but are not limited to, a smartphone, tablet, laptop, multi-processor systems, microprocessor-based or programmable consumer electronics, game consoles, set-top boxes, a server, or any other communication device that can access the network system 102. The client device 106 and seller device 108 may comprise a display module (not shown) to display information (e.g., in the form of user interfaces). The client device 106 and/or the seller device 108 can be operated by a human user and/or a machine user.

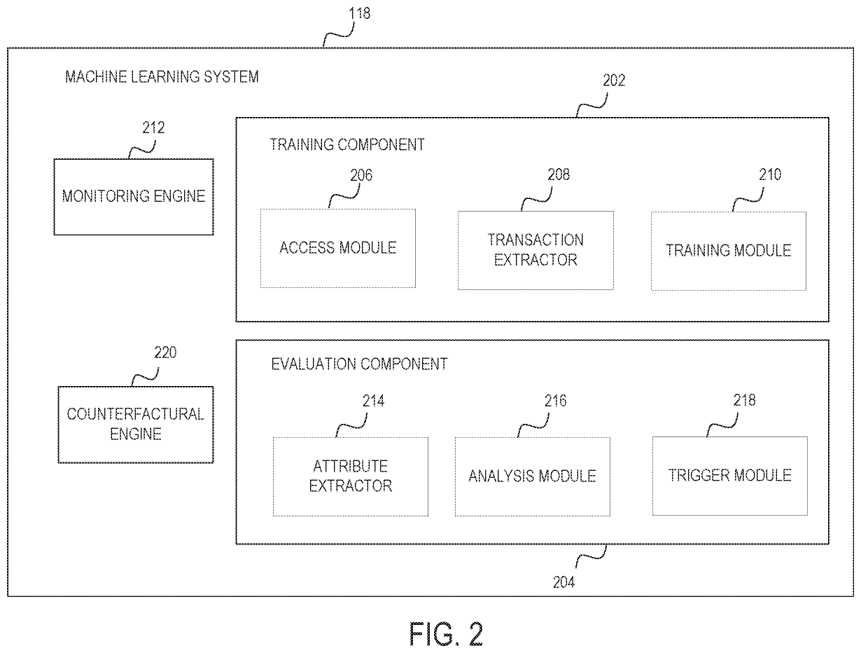

Turning specifically to the network system 102, an application programing interface (API) server 110 and a web server 112 are coupled to, and provide programmatic and web interfaces respectively to, one or more networking servers 114. The networking server(s) 114 host a transaction system 116 and a machine learning system 118, each of which comprises a plurality of components, and each of which can be embodied as hardware, software, firmware, or any combination thereof. The machine learning system 118 will be discussed in more detail in connection with FIG. 2.

The transaction system 116 is configured to manage listings and transactions at the network system 102 including publishing listings, processing offers and payment, and managing shipment of items. To enable these operations, the transaction system 116 may comprise a publication system, a payment system, and/or a shipping engine all configured to communicate with one another (e.g., via a bus, shared memory, or a switch). The publication system publishes listings on the network system 102. As such, the publication system provides a number of publication functions and services to users (e.g., sellers) that access the networked system 102. For example, the publication system 202 can host a marketplace application that provides a number of marketplace functions and services to users, such as publishing, listing, and price-setting mechanisms whereby a seller may list (or publish information concerning) goods or services (also collectively referred to as “items”) for sale. The payment system manages payment information and processing of payments to complete the transaction. The shipping engine manages shipping information and the shipping process.

The networking servers 114 are, in turn, coupled to one or more database servers 120 that facilitate access to one or more storage repositories or data storage 122. The data storage 122 is a storage device storing transaction histories of completed transactions, non-completed transactions, and user accounts (e.g., profiles associated with a buyer or seller). Additionally or alternatively, the data storage 122 is a storage device that can store the machine-trained probability conversion model (or a version of the machine-trained probability conversion model).

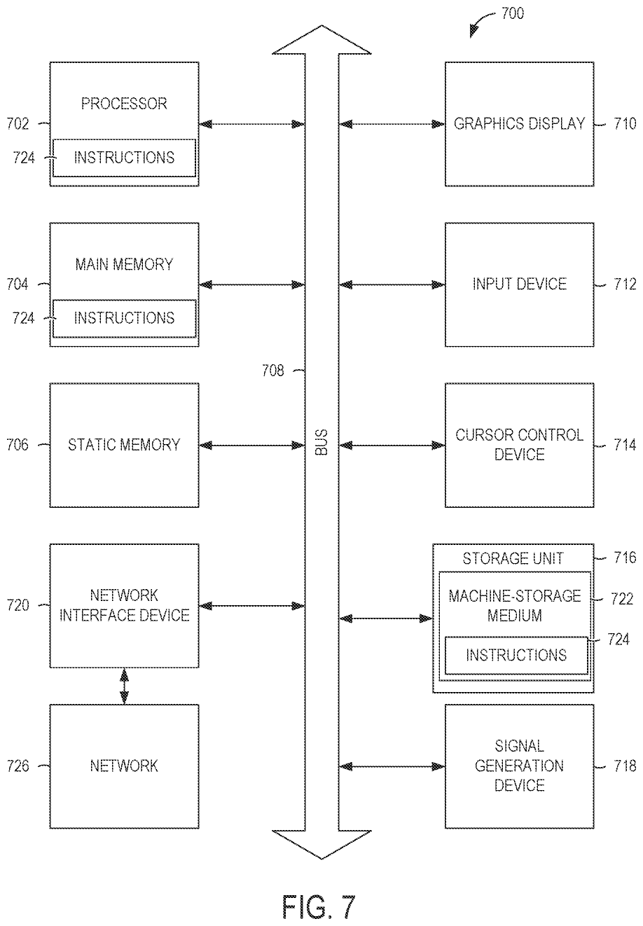

Any of the systems, servers, data storage, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, some functionalities of the transaction system 116 may be embodied in the machine learning system 118 and/or vice-versa. Additionally, any number of client devices 106, seller devices 108, or data storage 122 may be embodied within the network environment 100. While only a single network system 102 is shown, alternatively, more than one network system 102 can be included (e.g., localized to a particular region).

FIG. 2 is a is a diagram illustrating components of an example machine learning system 118, according to example embodiments. The machine learning system 118 is configured to train the conversion probability model. During runtime, the machine learning system 118 also monitors user account behavior associated with a user account of a potential buyer and uses the conversion probability model to determine a probability for transaction conversion based on the user account behavior. The machine learning system 118 can then trigger a counterfactual analysis and automatically implement a change associated with an item to increase the probability. In some cases, the machine learning system 118 determines a probability for each next action that the user of the user account may perform (e.g., add an item to cart, complete a checkout process) selects one of the next actions (e.g., a highest probability next action) to conduct counterfactual analysis with.

To enable these operations, the machine learning system 118 includes a training component 202, an evaluation component 204, a monitoring engine 212, and a counterfactual analysis engine 220 all configured to communicate with each other (e.g., via a bus, shared memory, or a switch). While FIG. 2 shows the training component 202 and the evaluation component 204 being embodied within the machine learning system 118, alternatively, the training component 202 can be separate from the evaluation component 204 in a different system or server. For example, the evaluation component 204 may be a part of the transaction system 116.

In example embodiments, the training component 202 trains the conversion probability model using training data derived from past transactions (both completed and non-completed) that occurred via the network system 102 (e.g., facilitated by the transaction system 116). The machine learning can occur using linear regression, logistic regression, a decision tree, an artificial neural network, k-nearest neighbors, and/or k-means, to name a few examples. The training component 202 can comprise an access module 206, a transaction extractor 208, and a training module 210.

The access module 206 accesses a data storage (e.g., data storage 122) that stores past transactions involving items. The access module 206 may identify and group past transactions, for example, based on item categories, locations of users, items, or sellers; completed transactions; incomplete transactions (e.g., transactions where the buyer performed actions with the transaction system 116 but did not complete purchase of the items); and/or time frame. The access module 206 can thus select the types or groups of past transactions used to train the conversion probability model. As such, the access module 206 can operate as a filter to select the past transactions from which features will be extracted to train the conversion probability model (e.g., for a specific location, specific category, specific range of prices). For example, past transactions can be grouped by location to generate regional conversion probability models (e.g., for different countries or states). In some cases, the access module 206 does not filter the past transactions but merely uses all past transactions in a particular time frame.

The transaction extractor 208 is configured to extract training data from the past transactions. For example, the transaction extractor 208 extracts item attributes (e.g., prices, shipping options, shipping costs, versions, reviews), seller account attributes (e.g., ratings, location, time on transaction system 116), and/or user account attributes (e.g., location of user accounts, prices from past transactions, items from past transactions, user preferences, length of time on the transaction system 116, the sellers from the past transactions, and/or whether the transactions were completed or not completed). The user account attributes can also include user behavior information, such as a sequence of actions, events, or operations (all used interchangeably throughout) that each user performed (e.g., what each user clicked on or viewed and in what order) before completing a transaction (e.g., completing a checkout process with a cart) or not completing a transaction (e.g., merely adding items to a cart to compare items, deleting items from the cart, saving the cart or item listing for later). The extracted data is then passed to the training module 210.

The training module 210 trains the conversion probability model using, for example, neural networks or classical machine learning. The training data used for training may include the item attributes, seller account attributes, and/or user account attributes (collectively referred to as “features”) for the past transactions in any combination. The training of the conversion probability model may include training for probabilities (e.g., thresholds and/or ranges) of whether a user will complete a transaction (e.g., that a next action performed by the user is or will lead to checkout completion). The machine training can occur using, for example, linear regression, logistic regression, a decision tree, an artificial neural network, k-nearest neighbors, and/or k-means.

The conversion probability model is trained to predict a proclivity for a user, at runtime, to complete a checkout process (i.e., complete the transaction). Thus, the machine learning system 118 can predict when a user is close to or exceeds a threshold (e.g., above 50% or 0.5 on a scale of 0 to 1; above 60% or 0.6) that they are likely to complete a purchase versus the user just browsing/clicking through listings and adding items to a cart or list.

The monitoring engine 212 is configured to monitor user account behavior associated with a user account of a potential buyer as they navigate pages served by the transaction system 116 during a current online session. The monitoring includes tracking a series of actions performed by the user (or user account) as the user traverses pages of the online session. The pages can include listings for different items, a search result user interface (e.g., based on an item search request), and/or a cart user interface (also referred to herein as a “checkout user interface”). The monitored actions can include, for example, displaying a listing, displaying the cart user interface, adding or deleting an item to the cart, lingering on a page, providing an indication to save the item to a list (e.g., wishlist, watchlist) or save the cart, and/or leaving an online shopping session. The monitoring may also include tracking a length of time spent displaying pages (e.g., the listing, the cart user interface). The length of time can indicate whether the user is lingering on a page and trying to decide what to do.

During runtime, the evaluation component 204 of the machine learning system 118 is configured to determine a probability for transaction conversion based on attributes associated with the monitored user account behavior, item attributes associated with an item that the user interacted with (e.g., viewing, adding the item to cart), and user account attributes and configured to trigger counterfactual analysis if the probability is low, in accordance with some embodiments. In other embodiments, the evaluation component 204 is configured to determine a probability for one or more next possible actions that can be performed by the user which may result in transaction conversion and trigger counterfactual analysis to increase the probability for one of the next possible actions. To perform these operations, the evaluation component 204 comprises an attribute extractor 214, an analysis module 216, and a trigger module 218.

During runtime, the attribute extractor 312 can access the user account data (e.g., profile or account history associated with the user account stored in the data storage 122) and determine user account attributes such as, for example, user account location, a number of completed and non-completed transactions, a length of time the user account has been active on the network system 102, an average price paid per item, a frequency of transactions, an average completed transaction amount, feedback scores, and/or user behaviors for both completed transactions and non-completed transactions. For instance, the user behaviors can include a series of actions performed prior to transaction completion, time spent viewing pages before performing an action (e.g., adding to cart, moving on to another page), how the user arrives at various pages (e.g., listings, checkout cart), and so forth.

In another example, the attribute extractor 214 can access the account profile or account history associated with the seller account associated with the item and determine seller account attributes such as, for example, a length of time or experience of the seller account with the network system 102 (e.g., seller tenure), a seller volume, a location (e.g., whether it is a shipping location or a drop ship location), and/or seller ranking and factors (e.g., fast shipper, items not received, cancellations).

Additionally, the attribute extractor 214 can access a listing associated with an item that the user is interacting with (e.g., viewing the listing of the item, adding the item to the cart) and determine item attributes such as, for example, a current price or price point of the item, a reserve price, a category, an associated shipping cost, a quantity available of the item, and/or related items (e.g., often purchased with the item).

In cases where the current action is the user displaying a checkout user interface (also referred to as a “cart user interface”), the attribute extractor 214 can also determine attributes associated with the cart. These attributes (also referred to as “item attributes”) can include, for example, payment methods available, site identifiers, currency, number of items in the cart, average price of items in the cart, and/or creation time (e.g., indicates how long have the items been in the cart).

The extracted attributes are then passed to the analysis module 216, which applies the extracted attributes to the conversion probability model. In a first embodiment, the output of the conversion probability model is a probability for transaction conversion (e.g., probability that the user will complete a checkout process). The probability may be compared, by the trigger module 218, to a conversion threshold to determine if the probability transgresses the conversion threshold. In a second embodiment, the output of the conversion probability model is a probability for one or more next actions that the user may perform. Thus, for example, the probability may be for completing a checkout process, similar to the embodiment discussed above. Alternative, the probability can be a probability that the user will view a different listing or a probability that the user will add an item to their cart, for example.

If the probability does not transgress a conversion threshold (e.g., being less than the conversion threshold), the trigger module 218 triggers the counterfactual engine 220 to perform counterfactual analysis. The counterfactual analysis identifies a change associated with the item that results in the conversion probability increasing (e.g., potentially exceeding the conversion threshold). Thus, the counterfactual engine 220 performs a simulation to determine which parameters/attributes can be changed in order to nudge the user over a decision boundary for completing the transaction (e.g., increase the conversion probability to above the conversion threshold). For instance, a price can be changed, a seller can be changed, a location of the item changed, or an upgraded version of the item can be suggested. Based on how the user is shopping on the site (e.g., based on the user account behavior) and the predicted proclivity for checkout, the counterfactual engine 202 can simulate what a transaction completion representation would look like based on an adjustment to an attribute or parameter, and then offer the user that adjustment.

In example embodiments, the counterfactual engine 220 may identify at least a first adjustment and a second adjustment to the item attribute. The counterfactual engine 220 then applies the user attribute(s), the item attribute(s) with the first adjustment, and the user account behavior to the conversion probability model to determine a first adjusted probability. Similarly, the counterfactual engine 220 applies the user attribute(s), the item attribute(s) with the second adjustment, and the user account behavior to the conversion probability model to determine a second adjusted probability. The counterfactual engine 220 then determines which of the first adjusted probability or the second adjusted probability is the higher adjusted probability. In some cases, the adjustment with the higher adjusted probability is automatically implemented. In other cases, the adjustment with the higher adjusted probability is automatically implemented if the higher adjusted probability exceeds the conversion threshold. While only two adjustments are discussed, any number of adjustments may be modeled to determine the highest adjusted probability.

In some cases, the counterfactual engine 220 models (e.g., determines the probability) and dynamically adjusts a cost associated with the item displayed on the cart user interface. For instance, the dynamically adjusting the cost associated with the item can be reduction of a shipping cost, lowering a price of the item, or providing a coupon for the item. The dynamically adjusted cost may be associated with an acceptance time period for completing a transaction. For example, if user is displaying a cart user interface and the user completes a checkout in the next five minutes, the discount (e.g., 10% off; a coupon for 10% off; reduced shipping cost) will be applied.

The counterfactual engine 220 can also model and adjust other elements associated with the item. In some cases, if the user is displaying the cart user interface, the change can be an upsell of the item. For instance, the counterfactual engine 220 can cause a display of an option for an upgraded version of the item. As an example, the user may have added a mobile phone with 16 gigs. The counterfactual engine 220 may provide an option to upgrade the item to a mobile phone with 32 gigs from the same seller.

In another example, if the user is displaying the cart user interface, the counterfactual engine 220 can cause display of a higher quantity offer that includes the item for a discount. For instance, if the cart user interface includes a dozen golf balls for $10, the adjustment can be an upsell to two dozen golf balls for $18.

In some cases, the counterfactual engine 220 can model and adjust an element associated with the item in response to the action of the user displaying a listing of the item. For example, if the user is displaying the listing for an amount of time that exceeds a linger threshold (e.g., indicating that the user is lingering on the listing and possibly deciding whether to add the item to cart), the counterfactual engine 220 can model an adjustment in cost or provide of an incentive. In some cases, the adjusted element (e.g., lower price, discount/coupon available or applied) is associated with an acceptance time period for adding the item to a cart. In some cases, the counterfactual engine 220 causes a listing user interface displaying the listing to dynamically change as the user is viewing the listing user interface to display the adjusted cost, the incentive (e.g., a coupon), and/or the acceptance time period.

In some cases, the counterfactual engine 220 models and dynamically adjusts an element associated with the item in response to an action of the user saving the item to a list (e.g., a watchlist or wishlist). For example, if the user provides an indication to save an item displayed in a listing that the user is displaying, the counterfactual engine 220 can model an adjustment in cost and, given the higher probability, change the cost associated with the item. In some cases, the adjusted element (e.g., lower price, discount/coupon available or applied) is associated with an acceptance time period for adding the item to a cart. In some cases, the counterfactual engine 220 causes a notification to be presented on a user interface indicating the item, the adjusted cost, and/or the acceptance time period. For example, the notification can be presented immediately in response to the item being added to the list.

The monitoring, evaluation, and counterfactual analysis occurs in real-time as the user is traversing through (e.g., displaying) pages provided by the transaction system 116. Thus, machine learning system 118 can perform a series of evaluations, one for each action performed by the user. For example, the user may display a first listing for a first item (e.g., a first action) and a probability for transaction conversion is determined for this first action. Then, the user may display a second listing for a different item having different item attributes and a second probability for transaction conversion is determined. The user can then add the item in the second listing to a cart and view the cart user interface. Here, a further transaction probability can be determined. With each transaction probability determination, counterfactual analysis and automatic implementation of a change can be triggered.

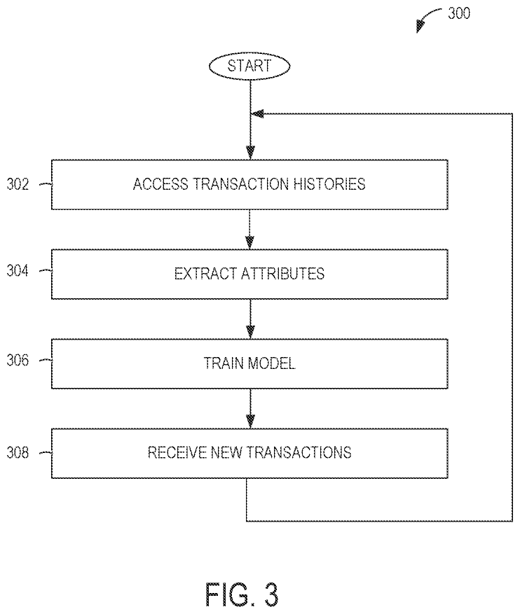

FIG. 3 is a flowchart illustrating operations of an example method 300 for machine-training a conversion probability model. Operations in the method 300 may be performed by the machine learning system 118, using components described above with respect to FIG. 2. Accordingly, the method 300 is described by way of example with reference to the machine learning system 118. However, it shall be appreciated that at least some of the operations of the method 300 may be deployed on various other hardware configurations or be performed by similar components residing elsewhere in the network environment 100. Therefore, the method 300 is not intended to be limited to the machine learning system 118.

In operation 302, the machine learning system 118 accesses pass transaction

histories associated with the transaction system 116. In some cases, the access module 206 accesses a data storage (e.g., data storage 122) that stores the transaction histories. In some cases, the access module 206 may identify and group/cluster past transactions, for example, based on item categories, locations of users or sellers, completed transactions, and/or non-completed transactions (e.g., where the buyer did not purchase an item).

In operation 304, the transaction extractor 208 extracts features (e.g., training data) from the past transactions. For example, the transaction extractor 208 can extract item attributes, seller account attributes, and/or user account attributes including locations of items, use accounts, and/or seller accounts; prices for items; and whether the transactions were completed or not completed. The transaction extractor 208 also extracts or identifies a sequence of actions/operations performed for each transaction. The sequence of actions/operations can be associated with an amount of time or timestamps. The extracted data is then passed to the training module 210.

In operation 306, one or more conversion probability models are trained by the training module 210. In example cases, the extracted features from operation 304 are provided to the training module 210. The machine learning can occur using, for example, linear regression, logistic regression, a decision tree, an artificial neural network, k-nearest neighbors, and/or k-means. The training of the conversion probability model may include calculating probabilities for transaction conversions based on different combinations of extracted features.

In operation 308, new transactions (both complete and non-complete) are received as they are performed by the transaction system 116. The new transactions may be stored to the data storage and subsequently used to retrain/refine the conversion probability model. Thus, operations 302 to 308 of the method 300 are periodically repeated.

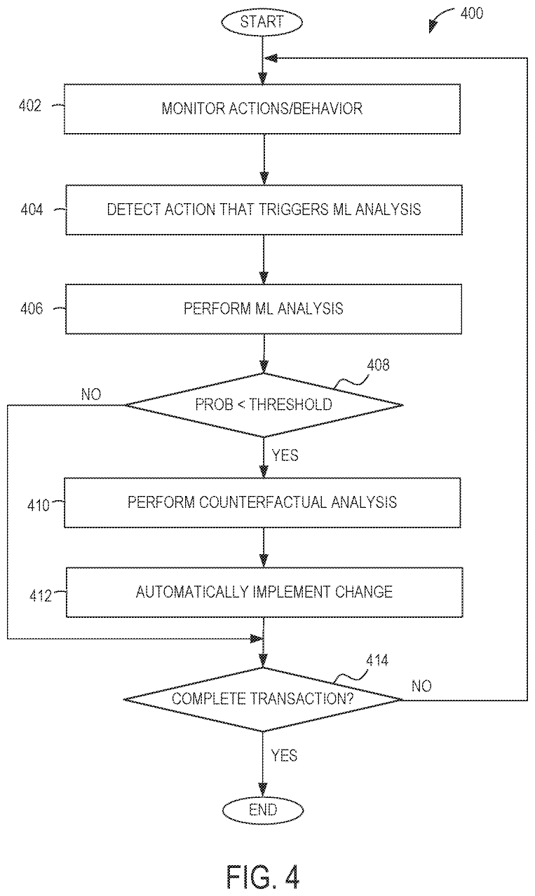

FIG. 4 is a flowchart illustrating operations of a method 400 for dynamically personalizing elements of an online session based on counterfactual machine-learning analysis, according to example embodiments. Operations in the method 400 may be performed by the network system 102, using components described above with respect to FIG. 1 and FIG. 2. Accordingly, the method 400 is described by way of example with reference to the network system 102 (e.g., the transaction system 116 and the machine learning system 118). However, it shall be appreciated that at least some of the operations of the method 400 may be deployed on various other hardware configurations or be performed by similar components residing elsewhere in the network environment 100. Therefore, the method 400 is not intended to be limited to the network system 102.

In operation 402, the monitoring engine 212 monitors actions or behaviors associated with a user account of a potential buyer as they navigate through pages served by the transaction system 116. The monitoring includes tracking a series or sequence of actions performed by the user (or user account) involving the pages. The pages can include listings for different items, a search result user interface (e.g., based on an item search request), a cart user interface (also referred to herein as a “checkout user interface”). The monitored actions can include, for example, displaying a listing, displaying a cart user interface, adding an item to the cart, and/or providing an indication to save the item to a list. The monitoring may also include tracking a length of time spent displaying various pages (e.g., the listing, the cart user interface).

In operation 404, the monitoring engine 212 detects an action that triggers machine-learning analysis. For example, displaying a search result page may not trigger the machine-learning analysis. However, viewing a cart user interface will trigger the machine-learning analysis. In some embodiments, viewing a listing may also trigger the machine-learning analysis.

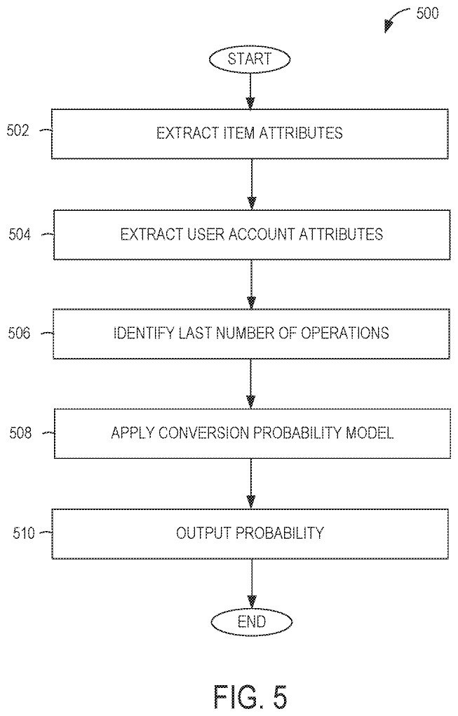

In operation 406, the evaluation component 204 performs the machine-learning analysis to determine a probability for transaction conversion. Operation 406 will be discussed in more detail in connection with FIG. 5 below.

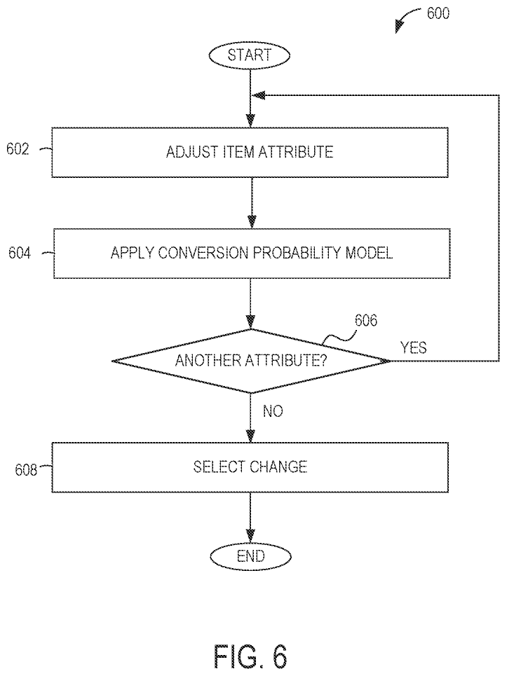

In operation 408, a determination is made whether the probability for transaction conversion is less than a predetermined conversion threshold (e.g., 51% or 0.51, 70% or 0.7). If the probability is less than the conversion threshold, a counterfactual analysis is performed in operation 410. Operation 410 will be discussed in more detail in connection with FIG. 6 below.

In operation 412, the counterfactual engine 220 automatically implements the change identified from the counterfactual analysis. In some embodiments, the change can be an adjustment to a price associated with the item (e.g., reduction in price of item, coupon made available, lowering of shipping cost). In some embodiments, the change can be an incentive or promotion associated with the item. For instance, the counterfactual engine 220 can cause a display of an offer for an upgraded version of the item, a buy two get one free offer, or a cashback offer. Any of the changes can have a time element. For example, an offer may only be available for a predetermined amount of time (e.g., within the next five minutes) or have an expiration date/time.

If in operation 408, a determination is made that the probability is greater than the conversion threshold, then the method 400 proceeds to operation 414. For example, if the actions include the user adding the item to their cart and the user has a history of purchasing every item they add to the cart, then the probability is greater than the conversion threshold. Therefore, no counterfactual analysis or changing of an attribute associated with the item (e.g., lowering a price or providing a discount) is necessary.

In an alternative embodiment, the counterfactual analysis may always be triggered regardless of the probability. In this alternative embodiment, the counterfactual analysis is used to determine an adjustment that will increase the probability and nudge the user to perform the next action (e.g., complete checkout, add item to the cart).

In operation 414, a determination is made if the transaction is completed (e.g., user pays for purchase of the item). If the transaction is completed, then the method 400 ends. However, if the transaction is not completed, the method 400 returns to operation 402 and monitors actions of the user account. For example, the user may continue to view additional listings and add more items to their cart before completing the transaction. Thus, the method 400 continues until the user either completes a transaction or ends a current online session with the transaction system 116. As such, the method 400 is continuous during an online session with the transaction system 116 and updates as the user traverse the pages.

FIG. 5 is a flowchart illustrating operations of a method 500 for performing, during runtime, machine-learning analysis based on user account actions (e.g., operation 406), according to example embodiments. Operations in the method 500 may be performed by the network system 102, using components described above with respect to FIG. 2. Accordingly, the method 500 is described by way of example with reference to the machine learning system 118. However, it shall be appreciated that at least some of the operations of the method 500 may be deployed on various other hardware configurations or be performed by similar components residing elsewhere in the network environment 100. Therefore, the method 500 is not intended to be limited to the network system 102.

In operation 502, the attribute extractor 312 extracts item attributes associated with the item. In example embodiments, the attribute extractor 214 can access a listing associated with the item that the user is interacting with (e.g., viewing the listing of the listing, added the item to cart) and determine item attributes such as, for example, a current price or price point of the item, a reserve price, a category, an associated shipping cost, a quantity available of the item, and/or related items (e.g., often purchased with the item).

In operation 504, the user account attributes are extracted. In example embodiments, the attribute extractor 312 accesses user account data (e.g., profile or account history associated with the user account stored in the data storage 122) and extracts user account attributes such as, for example, user account location, an average price paid per item, a number of transactions completed or not completed, a frequency of transactions, an average completed transaction amount, and/or user behaviors that led to both completed transactions and non-completed transactions. For instance, the user behaviors can include a series of actions performed prior to transaction completion, time spent viewing pages before performing an action (e.g., adding to cart, moving on to another page), how the user arrives at various pages (e.g., listings, checkout cart), and so forth.

In operation 506, the monitoring engine 212 identifies a last predetermined number of actions or operations (e.g., last 5 or 8 operations) performed by the user immediately prior to, and including, the current action that triggers the machine-learning analysis. The last predetermine number of operations indicates the user account behavior (e.g., the way in which the user account has traversed the pages over time) that will be applied in the machine-learning analysis. In one embodiment, the evaluation component 204 predicts based on, for example, the user's current action (e.g., adding an item to the cart, saving the item for later), the sequence of actions performed, and an amount of time taken to perform each action, what the probability is the user will checkout as a next step.

In operation 508, the analysis module 314 applies the extracted attributes (e.g., user account and item attributes) and user account behavior to the conversion probability model. In some embodiments, the analysis looks at what the user did the last predetermined number of operations and predicts what the probability is that the next operation is completing a checkout or will lead to completing the checkout. In some embodiment, the analysis looks at what the user did the last predetermined number of operations and predicts probabilities for what the next operation(s) may be (e.g., checkout out, adding an item to the cart).

In operation 510, the probability is outputted by the analysis module 216. In a first embodiment, the output of the conversion probability model is a probability for transaction conversion (e.g., probability that the user will complete a checkout process). In a second embodiment, the output of the conversion probability model is a probability for one or more next actions that the user may perform.

FIG. 6 is a flowchart illustrating operations of an example method 600 for performing counterfactual analysis (e.g., operation 410), according to example embodiments. Operations in the method 600 may be performed by the network system 102, using components described above with respect to FIG. 2. Accordingly, the method 600 is described by way of example with reference to the network system 102 (e.g., the machine learning system 118). However, it shall be appreciated that at least some of the operations of the method 600 may be deployed on various other hardware configurations or be performed by similar components residing elsewhere in the network environment 100. Therefore, the method 600 is not intended to be limited to the network system 102.

As previous discussed, counterfactual analysis attempts to identify an adjustment to an attribute or element that nudges the user towards completing the transaction or to perform the next operation (e.g., increasing the conversion probability). For example, if the current action is the user viewing/displaying a listing, the nudge is to add the item to the cart. In another example, if the current action is adding the item to the cart, then the nudge is to checkout (e.g., view the checkout user interface). In a further example, if the current action is viewing the cart or checkout user interface, the nudge is to complete the checkout.

In operation 602, the counterfactual engine 220 adjusts an attribute associated with the item. In example embodiments, the counterfactual engine 220 identifies an adjustment that can be made and makes the adjustment. For example, if a user is in the process of displaying a listing page, the counterfactual analysis can be performed to determine what adjustment can be made to nudge the user into adding the item to the cart. One adjustment is changing the price as the page loads. An alternative adjustment is dynamically changing the price as the user is viewing the listing page. If the user is lingering on the listing page, a further adjustment is a discount if the user adds the item within a short time frame (e.g., in the next five minutes). All of these potential adjustments may be tested with the counterfactual analysis to determine which one or more adjustments to make.

In another example, the user can be viewing/displaying the listing page or the cart user interface and upsell adjustments tested. One adjustment may be a suggestion (e.g., a popup or notification) to add one or more additional same items for a discount (e.g., 10% off). Another adjustment may be a promotion such as buy two and get another free. A further adjustment may be suggesting an upgraded version of the item on the listing page or in the cart.

In a further example, the user can be viewing/displaying the cart user interface and the counterfactual analysis can be performed to determine what adjustment can be made to nudge the user to complete checkout (i.e., complete the transaction). One adjustment may be to provide a dynamic coupon as the user is viewing the cart user interface. The dynamic coupon can be associated with a time limit (e.g., checkout in the next five minutes and get 10% off). Another adjustment may be reducing shipping costs or upgrading the shipping for free (e.g., 2-day express for the price of ground shipping). The dynamic shipping adjustment can be associated with a time limit (e.g., checkout in the next five minutes and reduced shipping cost or upgraded shipping included). In a further example, the adjustment can be a promotion such as providing cashback if the user checkouts within a time limit (e.g., 10% cash back for next purchase) or a buy now, pay later option.

With respect to providing a discount or changing the price or shipping cost, the counterfactual analysis can test different amounts of the adjustment. This may be done in order to determine a minimum adjustment that will cause the conversion probability to transgress the conversion threshold or to increase the probability a threshold amount (e.g., 10%).

In operation 604, the analysis module 314 applies the conversion probability model. In example embodiments, the analysis module 314 applies the extracted user attributes, the item attribute with the adjustment, and the user account behavior to the conversion probability model. The result is an adjusted probability.

In operation 606, a determination is made whether there is another attribute that can be adjusted. If there is another attribute, then the method 600 returns to operation 602.

However, if there are no more attributes to test, then the method proceeds to operation 608 where one of the adjustments may be selected. In one embodiment, the selected adjustment is the adjustment having the highest conversion probability of all the adjustments that are tested by the method 600. The selected adjustment may then be automatically implemented in operation 412 in FIG. 4.

In an alternative embodiment, if the adjusted probability does not increase a threshold amount over the original probability (e.g., 5%) or does not exceed the conversion threshold, the corresponding adjustment may not be implemented by the counterfactual engine 220. Thus, the counterfactual engine 220 may make this determination prior to automatically implementing the selected change.

FIG. 7 illustrates components of a machine 700, according to some examples that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIG. 3 to FIG. 6. In one example, the instructions 724 can transform the general, non-programmed machine 700 into a particular machine (e.g., specially configured machine) programmed to carry out the described and illustrated functions in the manner described.

In alternative examples, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with one another via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-readable media (e.g., tangible and non-Attorney transitory machine-readable media). The instructions 724 may be transmitted or received over a network 726 via the network interface device 720.

In some examples, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed examples.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain examples are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some examples, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering examples in which hardware modules are temporarily configured (e.g., programmed), the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In examples in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some examples, the one or more processors or processor-implemented modules may be located in a single geographic location (e.g., within a home environment, an office environment, or a server farm). In other examples, the one or more processors or processor-implemented modules may be distributed across a number of geographic locations.

### EXAMPLES

Example 1 is a method for using counterfactual machine-learning analysis to increase a transaction probability. The method comprises training, by a network system, a conversion probability model with training data extracted from past transactions on the network system, the conversion probability model configured to determine a probability for transaction conversion based in part on user account behavior; monitoring the user account behavior associated with a user account of a potential buyer including tracking a first action performed by the user account involving an item of a listing; identifying, by one or more hardware processors of the network system, a user attribute associated with the user account and an item attribute associated with the item; based on the first action, determining the probability for transaction conversion involving the item by applying the user attribute, the item attribute, and the user account behavior to the conversion probability model; based on the probability being less than a conversion threshold, performing counterfactual analysis to identify a change associated with the item that results in the probability exceeding the conversion threshold; and automatically implementing the change by the network system without human interaction.

In example 2, the subject matter of example 1 can optionally include wherein the monitoring the user account behavior further comprises tracking a second action performed by the user account; and the determining the probability for transaction conversion comprises determining a first probability for transaction conversion after the first action and determining a second probability for transaction conversion after the second action.

In example 3, the subject matter of any of examples 1-2 can optionally include wherein the performing counterfactual analysis comprises identifying a first adjustment and a second adjustment associated with the item; applying the user attribute, the item attribute with the first adjustment, and the user account behavior to the conversion probability model to determine a first adjusted probability; applying the user attribute, the item attribute with the second adjustment, and the user account behavior to the conversion probability model to determine a second adjusted probability; and determining which of the first adjusted probability or the second adjusted probability is the higher adjusted probability.

In example 4, the subject matter of any of examples 1-3 can optionally include determining that the higher adjusted probability exceeds the conversion threshold, wherein the corresponding adjustment that results in the higher adjusted probability that exceeds the conversion threshold is the change that is automatically implemented.

In example 5, the subject matter of any of examples 1-4 can optionally include wherein the corresponding adjustment that results in the higher adjusted probability is the change that is automatically implemented.

In example 6, the subject matter of any of examples 1-5 can optionally include wherein the first action comprises displaying a cart user interface; and the dynamically performing the change comprises dynamically adjusting a cost associated with the item displayed on the cart user interface.

In example 7, the subject matter of any of examples 1-6 can optionally include wherein the dynamically adjusted cost is associated with an acceptance time period for completing a transaction.

In example 8, the subject matter of any of examples 1-7 can optionally include wherein the dynamically adjusting the cost associated with the item comprises reducing a shipping cost or providing an upgraded shipping option displayed on the cart user interface.

In example 9, the subject matter of any of examples 1-8 can optionally include wherein the dynamically adjusting the cost associated with the item comprises offering a lower price for the item displayed on the cart user interface.

In example 10, the subject matter of any of examples 1-9 can optionally include wherein the action comprises displaying a cart user interface; and the dynamically performing the change comprises displaying an option for an upgraded version of the item on the cart user interface.

In example 11, the subject matter of any of examples 1-10 can optionally include wherein the action comprises displaying a cart user interface; and the dynamically performing the change comprises displaying a higher quantity offer that includes more of the item for a discount on the cart user interface.

In example 12, the subject matter of any of examples 1-11 can optionally include wherein the action comprises displaying the listing associated with the item for an amount of time that exceeds a linger threshold; and the dynamically performing the change comprises dynamically adjusting, on the displayed listing, a cost associated with the item and displaying an acceptance time period for adding the item to a cart.

In example 13, the subject matter of any of examples 1-12 can optionally include wherein the action comprises displaying the listing associated with the item; and the dynamically performing the change comprises dynamically providing an incentive to add the item to a cart.

In example 14, the subject matter of any of examples 1-13 can optionally include wherein the action comprises providing an indication to save the item to a list; and the dynamically performing the change comprises dynamically adjusting a cost associated with the item added to the list and presenting an acceptance time period for adding the item to a cart.

In example 15, the subject matter of any of examples 1-14 can optionally include retraining the conversion probability model with training data extracted from a new transaction involving the item.

In example 16, the subject matter of any of examples 1-15 can optionally include wherein the conversion probability model comprises a long short-term memory model and the user account behavior applied to the conversion probability model includes the first action along with a last predetermine number of actions immediately prior to the first action.

Example 17 is a system for using counterfactual machine-learning analysis to increase a transaction probability. The system comprises one or more hardware processors and a memory storing instructions that, when executed by the one or more hardware processors, cause the one or more hardware processors to perform operations comprising training a conversion probability model with training data extracted from past transactions on the network system, the conversion probability model configured to determine a probability for transaction conversion based in part on user account behavior; monitoring the user account behavior associated with a user account of a potential buyer including tracking a first action performed by the user account involving an item of a listing; identifying a user attribute associated with the user account and an item attribute associated with the item; based on the first action, determining the probability for transaction conversion involving the item by applying the user attribute, the item attribute, and the user account behavior to the conversion probability model; based on the probability being less than a conversion threshold, performing counterfactual analysis to identify a change associated with the item that results in the probability exceeding the conversion threshold; and automatically implementing the change by the network system without human interaction.

In example 18, the subject matter of example 17 can optionally include wherein the operations further comprise retraining the conversion probability model with training data extracted from a new transaction involving the item.

In example 19, the subject matter of any of examples 17-18 can optionally include wherein the conversion probability model comprises a long short-term memory model and the user account behavior applied to the conversion probability model includes the first action along with a last predetermine number of actions immediately prior to the first action.

Example 20 is a computer-storage medium comprising instructions which, when executed by one or more hardware processors of a machine, cause the machine to perform operations for using counterfactual machine-learning analysis to increase a transaction probability. The operations comprise training a conversion probability model with training data extracted from past transactions on the network system, the conversion probability model configured to determine a probability for transaction conversion based in part on user account behavior; monitoring the user account behavior associated with a user account of a potential buyer including tracking a first action performed by the user account involving an item of a listing; identifying a user attribute associated with the user account and an item attribute associated with the item; based on the first action, determining the probability for transaction conversion involving the item by applying the user attribute, the item attribute, and the user account behavior to the conversion probability model; based on the probability being less than a conversion threshold, performing counterfactual analysis to identify a change associated with the item that results in the probability exceeding the conversion threshold; and automatically implementing the change by the network system without human interaction.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
training, by a network system, a conversion probability model with training data extracted from past transactions on the network system, the conversion probability model configured to determine a probability for transaction conversion based in part on user account behavior;
monitoring the user account behavior associated with a user account of a potential buyer including tracking a first action performed by the user account involving an item of a listing;
identifying, by one or more hardware processors of the network system, a user attribute associated with the user account and an item attribute associated with the item;
based on the first action, determining the probability for transaction conversion involving the item by applying the user attribute, the item attribute, and the user account behavior to the conversion probability model;
based on the probability being less than a conversion threshold, performing counterfactual analysis to identify a change associated with the item that results in the probability exceeding the conversion threshold; and
automatically implementing the change by the network system without human interaction.

2. The method of claim 1, wherein:
the monitoring the user account behavior further comprises tracking a second action performed by the user account; and
the determining the probability for transaction conversion comprises determining a first probability for transaction conversion after the first action and determining a second probability for transaction conversion after the second action.

3. The method of claim 1, wherein the performing counterfactual analysis comprises:
identifying a first adjustment and a second adjustment associated with the item;
applying the user attribute, the item attribute with the first adjustment, and the user account behavior to the conversion probability model to determine a first adjusted probability;
applying the user attribute, the item attribute with the second adjustment, and the user account behavior to the conversion probability model to determine a second adjusted probability; and
determining which of the first adjusted probability or the second adjusted probability is the higher adjusted probability.

4. The method of claim 3, further comprising:
determining that the higher adjusted probability exceeds the conversion threshold, wherein the corresponding adjustment that results in the higher adjusted probability that exceeds the conversion threshold is the change that is automatically implemented.

5. The method of claim 3, wherein the corresponding adjustment that results in the higher adjusted probability is the change that is automatically implemented.

6. The method of claim 1, wherein:
the first action comprises displaying a cart user interface; and
the dynamically performing the change comprises dynamically adjusting a cost associated with the item displayed on the cart user interface.

7. The method of claim 6, wherein the dynamically adjusted cost is associated with an acceptance time period for completing a transaction.

8. The method of claim 6, wherein the dynamically adjusting the cost associated with the item comprises reducing a shipping cost or providing an upgraded shipping option displayed on the cart user interface.

9. The method of claim 6, wherein the dynamically adjusting the cost associated with the item comprises offering a lower price for the item displayed on the cart user interface.

10. The method of claim 1, wherein:
the action comprises displaying a cart user interface; and
the dynamically performing the change comprises displaying an option for an upgraded version of the item on the cart user interface.

11. The method of claim 1, wherein:
the action comprises displaying a cart user interface; and
the dynamically performing the change comprises displaying a higher quantity offer that includes more of the item for a discount on the cart user interface.

12. The method of claim 1, wherein:
the action comprises displaying the listing associated with the item for an amount of time that exceeds a linger threshold; and
the dynamically performing the change comprises dynamically adjusting, on the displayed listing, a cost associated with the item and displaying an acceptance time period for adding the item to a cart.

13. The method of claim 1, wherein:
the action comprises displaying the listing associated with the item; and
the dynamically performing the change comprises dynamically providing an incentive to add the item to a cart.

14. The method of claim 1, wherein:
the action comprises providing an indication to save the item to a list; and
the dynamically performing the change comprises dynamically adjusting a cost associated with the item added to the list and presenting an acceptance time period for adding the item to a cart.

15. The method of claim 1, further comprising:
retraining the conversion probability model with training data extracted from a new transaction involving the item.

16. The method of claim 1, wherein the conversion probability model comprises a long short-term memory model and the user account behavior applied to the conversion probability model includes the first action along with a last predetermine number of actions immediately prior to the first action.

17. A system comprising:
one or more hardware processors; and
a memory storing instructions that, when executed by the one or more hardware processors, cause the one or more hardware processors to perform operations comprising:
training a conversion probability model with training data extracted from past transactions on the network system, the conversion probability model configured to determine a probability for transaction conversion based in part on user account behavior;
monitoring the user account behavior associated with a user account of a potential buyer including tracking a first action performed by the user account involving an item of a listing;
identifying a user attribute associated with the user account and an item attribute associated with the item;
based on the first action, determining the probability for transaction conversion involving the item by applying the user attribute, the item attribute, and the user account behavior to the conversion probability model;
based on the probability being less than a conversion threshold, performing counterfactual analysis to identify a change associated with the item that results in the probability exceeding the conversion threshold; and
automatically implementing the change by the network system without human interaction.

18. The system of claim 17, wherein the operations further comprise:
retraining the conversion probability model with training data extracted from a new transaction involving the item.

19. The system of claim 17, wherein the conversion probability model comprises a long short-term memory model and the user account behavior applied to the conversion probability model includes the first action along with a last predetermine number of actions immediately prior to the first action.

20. A machine-storage medium comprising instructions which, when executed by one or more hardware processors of a machine, cause the machine to perform operations comprising:
training a conversion probability model with training data extracted from past transactions on the network system, the conversion probability model configured to determine a probability for transaction conversion based in part on user account behavior;
monitoring the user account behavior associated with a user account of a potential buyer including tracking a first action performed by the user account involving an item of a listing;
identifying a user attribute associated with the user account and an item attribute associated with the item;
based on the first action, determining the probability for transaction conversion involving the item by applying the user attribute, the item attribute, and the user account behavior to the conversion probability model;
based on the probability being less than a conversion threshold, performing counterfactual analysis to identify a change associated with the item that results in the probability exceeding the conversion threshold; and
automatically implementing the change by the network system without human interaction.
